(19) United States
(12) Patent Application Publication
(10) Pub. No.: US 2009/0320069 A1
(43) Pub. Date: Dec. 24, 2009

(54) METHOD AND SYSTEM FOR ELECTRONIC PROGRAM GUIDE TEMPORAL CONTENT ORGANIZATION

(75) Inventors: Michael Ficco, Silver Spring, MD (US); Lou King, Ijamsville, MD (US); Sean Lee, Potomac, MD (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: The DIRECTV Group, Inc., El Segundo, CA (US)

(21) Appl. No.: 12/550,254

(22) Filed: Aug. 28, 2009

Related U.S. Application Data
(63) Continuation of application No. 10/022,049, filed on Dec. 17, 2001.
(60) Provisional application No. 60/296,548, filed on Jun. 7, 2001.

(51) Int. Cl. G06F 13/00

(52) U.S. Cl. 725/39; 725/151

(57) ABSTRACT

A method and system which temporally sorts data such as program guide data for example, to ensure that near-term data (i.e. most likely to be used, or “now data”) is always available for rapid access from a physical memory location such as a high-speed temporal cache. The method incorporates two low-priority background processes or algorithms, termed “event horizons” into the storage and manipulation of the data so that applications using the data may be run without having to always access a mass storage device. The method and system are highly applicable to all set top boxes (STBs) used in various communication systems such as satellite communication, Cable-TV and DVB systems. The method and system are economical in that superior STB and/or system performance may be obtained with the inclusion of lesser amounts of expensive high-speed RAM.

### CROSS REFERENCE TO RELATED CASES

This application is a continuation of U.S. utility patent application Ser. No. 10/022,049, filed Dec. 17, 2001, which claims the benefit of priority under 35 U.S.C. § 119(e) to U.S. Provisional Patent Application No. 60/296,548 of Michael Ficco, entitled “METHOD AND PROCESS FOR ELECTRONIC PROGRAM GUIDE TEMPORAL CONTENT ORGANIZATION,” filed on Jun. 7, 2001, the entire contents of which is incorporated by reference herein.

### BACKGROUND OF THE INVENTION

1. Field of the Invention

The present invention generally relates to communications systems that transmit data to various audio and video systems and more particularly to a method and system for efficiently organizing data for immediate access by the communication system and/or a user of the system.

2. Description of Related Art

In recent years, communications systems such as satellite communications systems, cable communications systems, digital video broadcasting (DVB) communications systems, terrestrial broadcast communications systems, etc., have been developed and refined for use by increasing numbers of commercial and household users. These systems typically transmit programming information for use by devices, such as set top boxes (STBs) that are coupled to devices such as televisions, personal computers (PCs), etc., of homes and businesses. Programming information consists of program that are being broadcast on specified channels at specified times. For example, the show “Friends” playing at 6:00 pm on channel 7. Programming information is accumulated and displayed in what is typically called an electronic program guides (“EPGs”), hereinafter referred to as “program guide” and/or “PG”. These program guides are displayed on the television, PC or other suitable display devices, for example.

The program guide is displayed, for example, in a matrix with times across the top of a suitable display screen in ½ hour increments, with channels along the left edge and with programs identified at the cross sections of the times and the channels. The program guide may also carry other useful information, such as actors, ratings, description of programs, etc. Such program guide data is typically stored in the STB for later retrieval and use by a program guide processor.

Typical systems employ random access memory (RAM) to store all program guide information. In an exemplary situation, it is possible to hold up to 3 days worth of program guide information in roughly 8 megabytes of RAM. However, the size and volume of data in program guides are dramatically increasing due to the continual addition of new channels and unique programs.

To be able to handle the increase of program guide information it is necessary to increase the amount of RAM that STBs have. However RAM comes at a premium cost which limits the viability of this solution. In one particular example, to store 14 days worth of program guide information estimates say that 21 megabytes of RAM will be consumed.

Another alternative to increasing the amount of RAM each STB has is to add a hard disk storage device to the STB. Hard disk storage devices provide a means of storing much greater amounts of data for a cheaper cost per megabyte. The tradeoff however is slower access times to data. In addition, these delays occur synchronously with the application's access and are exacerbated by situations such as where digital recording of programming content is competing for the hard drive's attention.

Additionally, virtual paging schemes that have been proposed to solve the above inefficiency problem suffer from the need to delay the requesting application for all situations where the page is not physically maintained in memory. And as previously described, any accesses to the hard drive will contend with other processes attempting to access data from the disk.

Further, heuristic caching (a suggested alternative to virtual paging) also fails to solve the efficiency problem due to the infrequent nature of the data accesses. Heuristic caching depends on cache hit/miss statistics to develop knowledge of the data that needs to be retained in cache. Unfortunately, typical program guide usage scenarios result in data becoming obsolete (i.e. historic) by the time the caching algorithm develops enough statistics to keep that data in the cache.

One factor falling in favor of this system is the fact that program guide usage by a user is predictable with varying amounts of certainty. Users are more likely to see which programs are playing within the next hour than checking to see which programs are playing 2 weeks from now. Likewise, it can be stated that most queries to the program guide will be requesting programming information within the next 6 hours than requesting programming information after the next 6 hours.

Accordingly, what is needed is a method and/or system which can efficiently sort program guide content to ensure that that data which is most likely to be used, i.e., “near-term” or “now data” is able to be rapidly and immediately accessed by a user while data which is less likely to be used, i.e., “far-term” or “later data” is available but can take a longer amount of time to be accessed.

### SUMMARY OF THE INVENTION

In light of the above deficiencies, the method and system of the present invention temporally sorts data such as program guide data for example, to ensure that the near term data (i.e. most likely to be used, or “now data”) is always available for rapid access from a physical memory location such as a RAM based high-speed temporal cache while “long term” data is available from a slower, more massive mass storage device. The method incorporates two low-priority background processes or algorithms to move programming information around from the hard disk drive to the RAM based high-speed temporal cache. This is done so that applications using the data may be run without having to always access a mass storage device.

The two processes operate on the concepts of “event horizons”. “Event horizons” are thresholds of time. In our case, we set one event horizon to be the present time. As current data slides into the past, this low-priority background process prunes the “now unneeded data” and deletes it from the RAM based high-speed temporal cache. We set another event horizon to be the 6 hours from the present time. The passage of time will bring “long term” programming information into the time window of the RAM based high-speed temporal cache. At this point the second process will move any such programming information into the RAM based high-speed temporal cache. In other words, the method and system of the present invention uses these low-priority background processes to marshal the appropriate data for inclusion into the high-speed temporal cache.

An aspect in this invention is the conversion of a large number of real time events into casual background processing. This low-priority background processing approach additionally reduces the contention for the mass storage device, thereby making the operation of other system features such as digital recording possible. The intelligent (i.e. application knowledgeable) caching of relevant data improves the overall performance of channel changing, program guide display, etc.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, wherein like elements are represented by like reference numerals, which are given by way of illustration only and thus are not limitative of the present invention and wherein:

FIG. 1 is an exemplary arrangement of a set-top box (STB) within a direct broadcast satellite or digital video broadcast system in accordance with the invention;

FIG. 2 illustrates a general data flow in a direct broadcast satellite or digital video broadcast system in accordance with the invention;

FIG. 3 illustrates an exemplary architecture of the STB 300 that is capable of temporally sort program guide content in accordance with the system of the present invention;

FIG. 4 is a block diagram showing an exemplary construction of a memory device according to the invention;

FIG. 5 is a flow diagram showing data flow for recording a program, broadcast or event for later playback in accordance with an exemplary embodiment of the invention;

FIG. 6 illustrates an alternative signal path for recording; and

FIG. 7 illustrates the method of organizing temporal program content in accordance with the invention.

### DETAILED DESCRIPTION

The method and system of the present invention temporally sorts PG content in a communication system having an STB for example, to ensure that the near term data (i.e. most likely to be used, “today's” data or “now data”) is always available for rapid access. This approach introduces two “event horizons” into the storage and manipulation of the program guide data.

The first “event horizon” occurs when current data becomes obsolete due to the passage of time. As current data slides into the past, a low priority background process prunes the “now unneeded data”. The second “event horizon” occurs when the passage of time brings new mass storage resident data into the time window of the system when it is eligible for inclusion into the high-speed temporal cache Additionally, the method uses a low-priority background process to marshal the appropriate data for inclusion into the high-speed temporal cache.

An aspect of the invention is the conversion of a large number of real time events into casual background processing. This low-priority background processing approach additionally reduces the contention for the mass storage device, thereby ensuring the operation of other system features such as digital recording possible. The intelligent (i.e. application knowledgeable) caching of relevant data improves the overall performance of channel changing, program guide display, etc.

Economy requires that most of the data in a program guide containing 2 to 3 weeks of information to be stored on some relatively slow mass storage device (a hard drive for example). 2 to 3 weeks of information would translate roughly to more than 21 megabytes of data. Intelligently organizing this data, as will be described below, yields a substantial real world performance advantage while maintaining an economical amount of high-speed storage.

As will be seen in more detail below, the present invention is highly applicable to all STBs used in various communication systems such as the aforementioned satellite communication, Cable-TV and DVB systems. The method and system are economical in the sense that superior STB and/or system performance may be obtained with lesser amounts of expensive high-speed RAM.

However, before describing the above features in greater detail, the inventors offer a general discussion on an exemplary satellite-based distribution system envisioned for the present invention, and more specifically discuss a STB equipped with a digital video recorder (DVR) within a direct broadcast satellite or digital video broadcast (DVB) system. Additionally, the basic architecture and operation of the STB is explained in order to provide a context for the method and system of the invention, which temporally sort PG content to ensure that the aforementioned “now data” is always available for rapid access.

In general, television signal distribution systems generally rely on either a cable network or on free-space propagation for delivering television signals to individual users or subscribers. Cable-based television systems transmit one or more individual television signals or “channels” over wire, while free-space propagation systems transmit one or more channels over-the-air, i.e., in a wireless manner. Most large-scale cable and wireless television signal distribution systems broadcast a broadband television signal having a plurality of individual television signals or channels modulated onto one or more carrier frequencies within a discernable frequency band.

Some wireless television signal distribution systems use one or more geo-synchronous satellites to broadcast a broadband television signal to receiver units within a large geographic area, while other wireless systems are land-based, using one or more transmitters located within smaller geographic areas to broadcast to individual receiver units within those geographic areas. An example of a land-based “cellular” type television signal distribution system is disclosed in Bossard, U.S. Pat. No. 4,747,160. This system includes multiple television signal transmitting stations, each of which transmits a television signal to individual receivers spread throughout a limited geographic region, and is configured so that adjacent transmitting stations use modulation and frequency diversity to prevent interference.

Some cellular systems, such as those commonly referred to as LMDS (local multi-point distribution system) and MMDS (multi-channel, multi-point distribution system), use a land-based cellular-type transmitting setup to rebroadcast satellite signals at frequencies different than the frequencies used by the satellite. Each of the transmitters of an LMDS system typically transmits within a one to five mile radius cell while each of the transmitters of an MMDS system typically transmits within an approximately 30-mile radius cell.

The present invention may be embodied in a satellite-based distribution system. The system generally includes an earth station that compiles a number of programs (video and audio) into a broadband signal, modulates a carrier frequency band with the broadband signal and then transmits (uplinks) the modulated signal to a geosynchronous satellite via a transmit antenna. The satellite amplifies the received signal, shifts the signal to a different carrier frequency band and transmits (downlinks) the frequency shifted signal to earth for reception at individual receiver stations.

The uplink and downlink broadband signals of the disclosed satellite distribution system may be divided into a plurality of transponder signals, each having a plurality of individual channels. For example, analog satellite systems operating in the so-called “G-band,” i.e., between about 3.7 GHz and about 4.2 GHz, typically broadcast ten (10)-500 MHz-wide transponder signals, with each transponder signal further including twelve, 40 MHz-wide analog channels. Satellite systems may also broadcast a set of transponder signals at multiple polarizations, for example, a right-hand circular polarization (RHCP) and a left-hand circular polarization (LHCP), within the band of carrier frequencies associated with the satellite; effectively doubling the number of channels broadcast by the system.

Satellite-based signal distribution systems exist for many frequency bands, including the so-called “Ku-band” which ranges from approximately 12 GHz to approximately 18 GHz. The preferred embodiment of the present invention uses an uplink signal having 16 RHCP transponder signals and 16 LHCP transponder signals modulated into the frequency band between about 17.2 GHz and about 17.7 GHz. Each of these 32 transponder signals includes data packets related to approximately 10 individual television channels associated therewith. The satellites shift the uplink transponder signals to carrier frequencies ranging from approximately 11.7 GHz to approximately 12.2 GHz and transmit these frequency-shifted transponder signals back to earth for reception at each of a plurality of individual receiver stations.

Each receiver station may include an antenna coupled to an STB that is equipped with a digital video recorder (DVR). In another embodiment, the STB may have interface circuitry coupled thereto for connection to an external digital peripheral unit such as a storage medium.

The antenna may comprise a parabolic dish antenna such as an outdoor unit (ODU) for example, pointed in the general direction of the transmitting satellite (or other transmitting location) to thereby receive the broadband signal. Such antennas may also include a low-noise block (LNB) downconverter, which filters and shifts the incoming signal to an intermediate frequency band, such as L-band, which is between approximately 1.0 GHz and approximately 2.0 GHz. In one embodiment, the signal received from the satellite is shifted to the frequency band between approximately 950 MHz and approximately 1450 MHz.

Sometimes, only the RHCP transponder signals or the LHCP transponder signals are mixed down to L-band, depending on which channel a user is viewing. However, in systems having a two-channel LNB downconverter, both the RHCP and the LHCP transponder signals are shifted down to L-band and provided, via separate lines, to the receiver station.

Although the present invention will be explained in reference to a STB within a direct broadcast satellite or digital video broadcast (DVB) system, the STB and/or STB-equipped with DVR may function within any of a cable TV, off-air broadcast or other applicable or known and used communication-related and/or wireless digital-TV system.

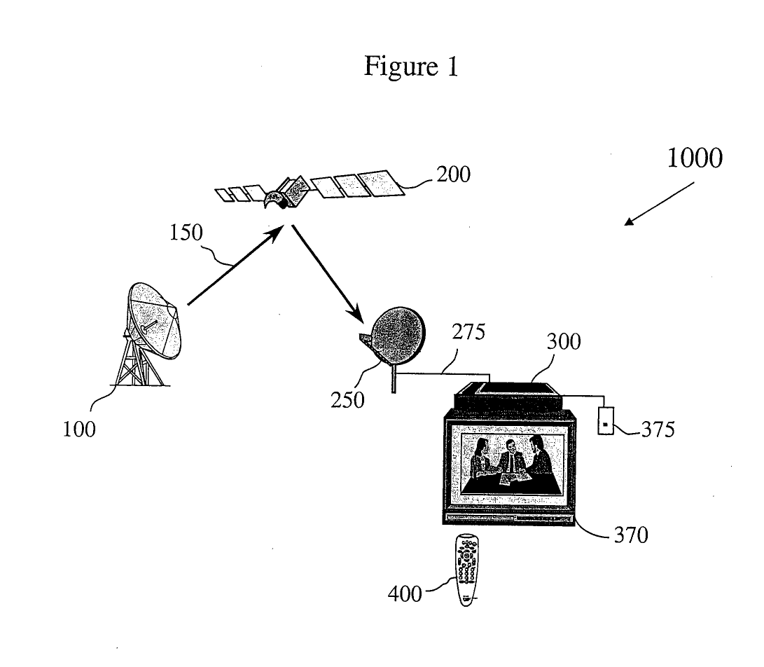

FIG. 1 is an exemplary arrangement of a STB 300 within a direct broadcast satellite or digital video broadcast (DVB) system, in accordance with the present invention. In the exemplary embodiment of FIG. 1, the system 1000 may comprise a transmit antenna station (hereinafter referred to as uplink facility 100 for clarity), satellite 200, receive antenna 250 and STB 300.

The transmit antenna station may be a DIRECTV® satellite uplink facility, for example, or any other earth station as described above and which is well known in the art. The bitstream or airlink 150 is a suitable content signal such as a digital audio and video television data signal (A/V signal), the medium is a satellite 200, and the receive antenna 250 is preferably an outdoor unit (ODU). As illustrated in FIG. 1, the ODU is connected to STB 300 via coaxial cable 275.

In this exemplary embodiment, a DVR of the present invention (not explicitly shown) is included in, or subsumed within STB 300. However, the invention is applicable to any STB having a multiple-processor configuration. STB 300 may further be connected to a display 370, such as a standard definition television, a high definition television or a PC monitor and also may be connected to a telephone line 375. The STB 300 may be controlled via a remote control 400 as is well known in art, using known RF and/or IR transmission and reception techniques.

The user command interface in the present invention however is not limited to a remote control device. Alternatively, any of function buttons residing on the STB structure itself, a keyboard operatively connected thereto and/or connected to a PC that is in communication with the STB, USP serial ports, voice-activation software devices within or operatively connected to the STB, or command and/or instructions by remote call-in using DTMF tones for example, may be substituted as the user command interface to the STB.

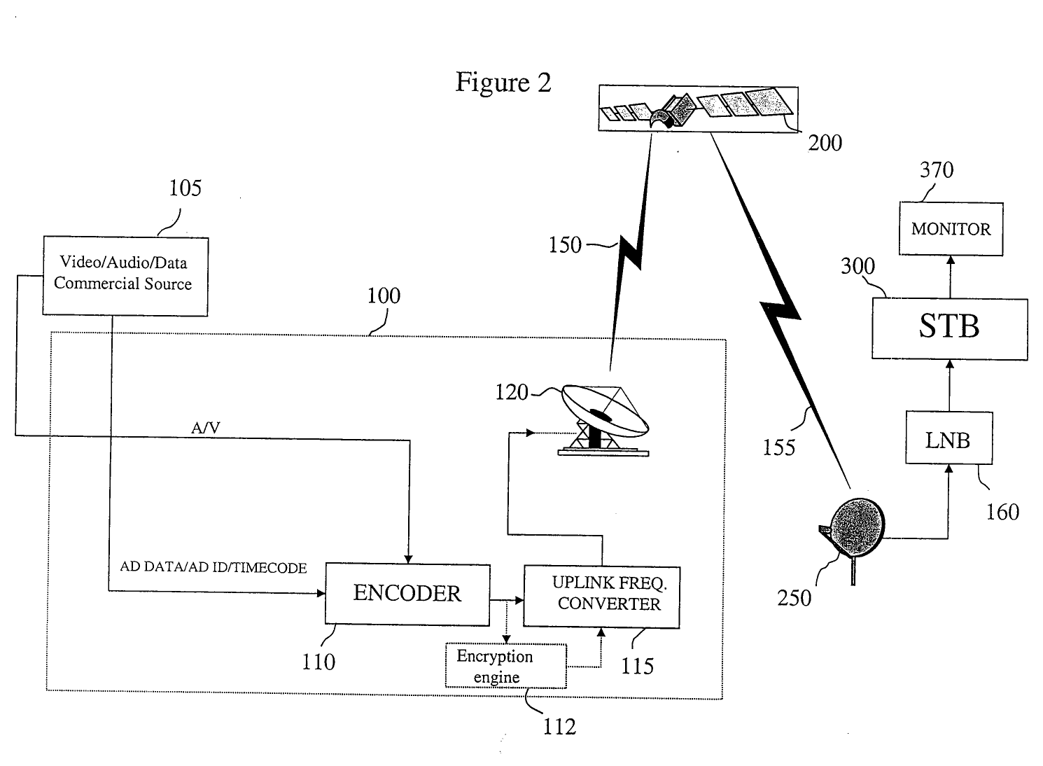

FIG. 2 illustrates the general data flow in a direct broadcast satellite or digital video broadcast system. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 110 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 which converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

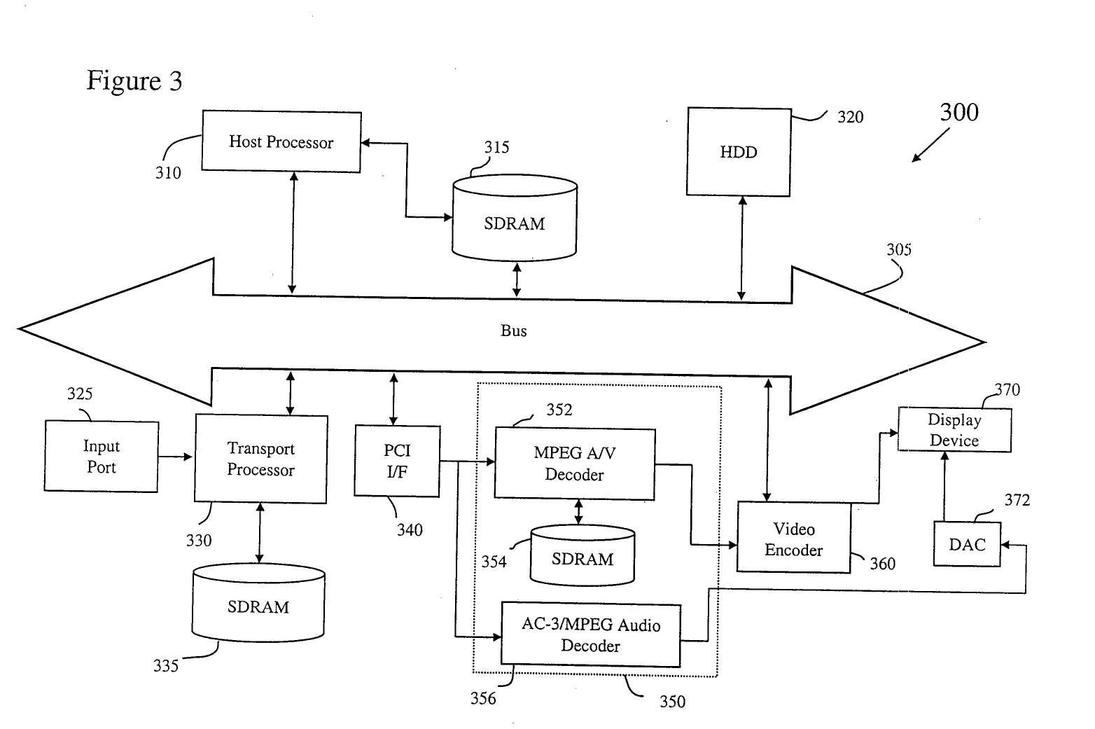

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 3) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

FIG. 3 illustrates an exemplary architecture of an STB 300 that is capable of temporally sort program guide content in accordance with the system of the present invention. The STB 300 utilizes a bus 305 to interconnect various components and to provide a pathway for data and control signals.

FIG. 3 illustrates a host processor 310, a memory device 315 (in an exemplary configuration embodied as an SDRAM 315) and a hard disc drive (HDD) 320 connected to the bus 305. In this embodiment, the host processor 310 may also have a direct connection to SDRAM 315 as shown in FIG. 3 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 3, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300, such as graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript™. Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause applications in STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 3 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

The input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 3 has been described in conjunction with digital television, the signal supplied could be any type of television signal, any type of audio or video data, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the decryption may be performed instead by the host processor 310.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (A/V) data may be sent to the host processor 310's memory (SDRAM 315) while simultaneously being sent to an MPEG A/V decoder 352, as further discussed below.

Decoder 350 may be constructed as shown in FIG. 3 by including the MPEG A/V decoder 352 connected to the PCI I/F 340, as well as an AC-3/MPEG audio decoder 356 which is also connected to the PCI I/F 340. In this way, the video and audio bitstreams from the PCI I/F 340 can be separately decoded by decoders 352 and 356, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

Video encoder 360 is preferably an NTSC encoder that encodes, or converts the digital video output from decoder 350 into a coded analog signal for display. Regarding the specifications of the NTSC (National Television Standards Committee) encoder 360, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. SECAM uses the same bandwidth as PAL but transmits the color information sequentially. SECAM runs on 625 lines/frame.

Thus, although use of a video encoder 360 is envisioned to encode the processed video for display on display device 370, the present invention is not limited to the NTSC standard encoder. PAL and SECAM encoders may also be utilized. Further, hi-definition television (HDTV) encoders may also be viable to encode the processed video for display on a HDTV, for example.

Display device 370 may be an analog or digital output device capable of handling a digital, decoded output from the video encoder 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices which are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from video encoder 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV system or other known systems which can reproduce the encoded audio and/or video signals for reproduction and/or display. This may also include a PC that can play video or audio files containing the encoded A/V data sent from the STB 300, for example.

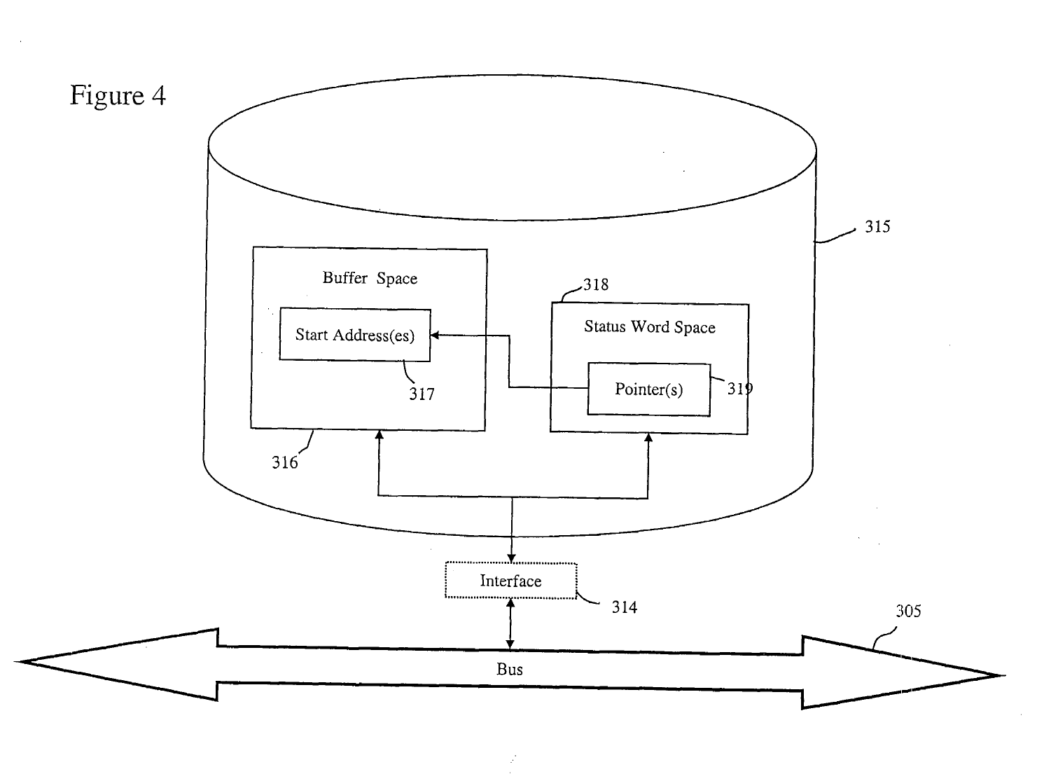

FIG. 4 illustrates various components that may be provided for the SDRAM 315. As mentioned above, the SDRAM shown in FIG. 3 is actually a specific implementation of a memory device. It is noted that the invention is not limited to this specific implementation of SDRAM 315 and can include any other known or future developed memory technology. Regardless of the technology selected, the memory device 315 may include a buffer space 316 which may be fixed or virtual set of memory locations that buffers or otherwise temporarily stores audiovisual data. In practice, the video data may be stored separate from the audio data, but it would be possible to intermix these data types depending upon the particular application and coding techniques utilized for the audio and visual data.

The audio visual data stored in the buffer space 316 includes one or more start addresses 317 which indicate the beginning memory address at which the audio and/or video data (A/V) is stored. If the A/V data is separately stored, then a plurality of stored addresses will be necessary. Furthermore, if there is more than one set of, or a block of data within the buffer space 316, then the start addresses 317 will individually point to each block of data.

The memory device 315 also includes a status word space 318. This status word space includes fixed or virtual addresses at which status words may be stored. An example of a status word that may be stored in the status word space 318 is a status word summarizing the status of a peripheral device. For example, the status word that may be stored within the status word space 318 may include the status of the host processor 310 or transport processor 330. The status word space 318 may also include pointers 319 that point to the start addresses 317 within the buffer space 316.

As further shown in FIG. 4, the SDRAM 315 may connect to the bus 305 via an interface 314. The dash lines indicate that the interface 314 is optional and may or may not be included depending upon the interface requirements of the particular memory device 315 and/or bus 305.

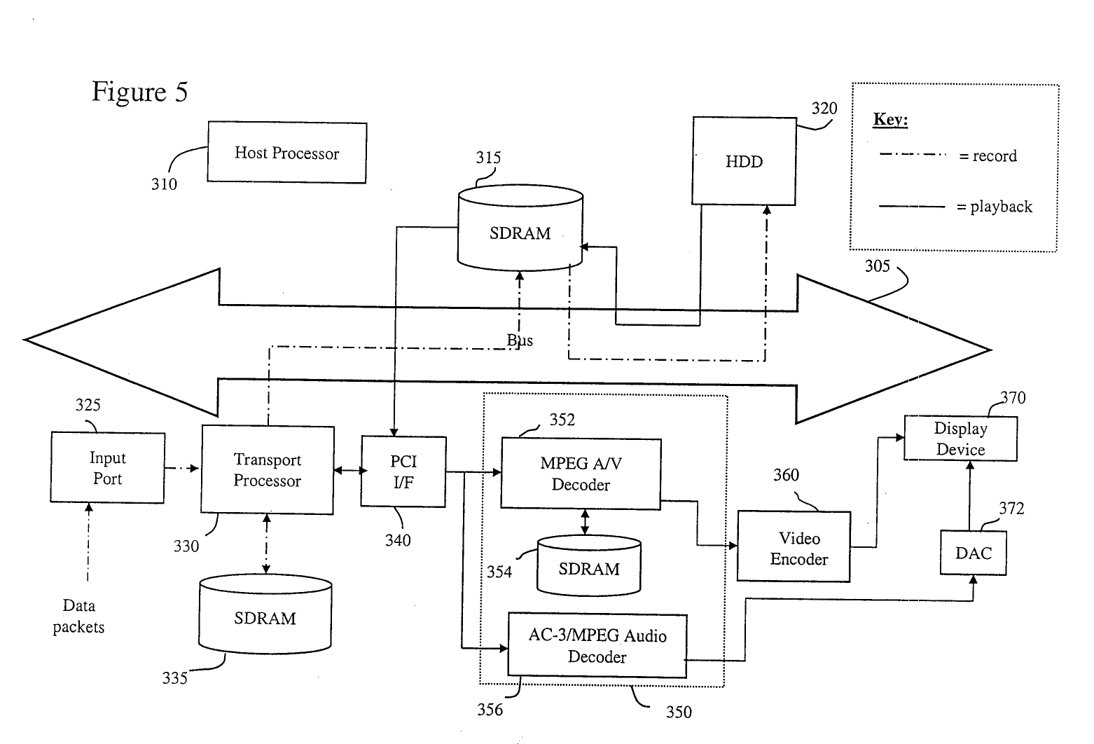

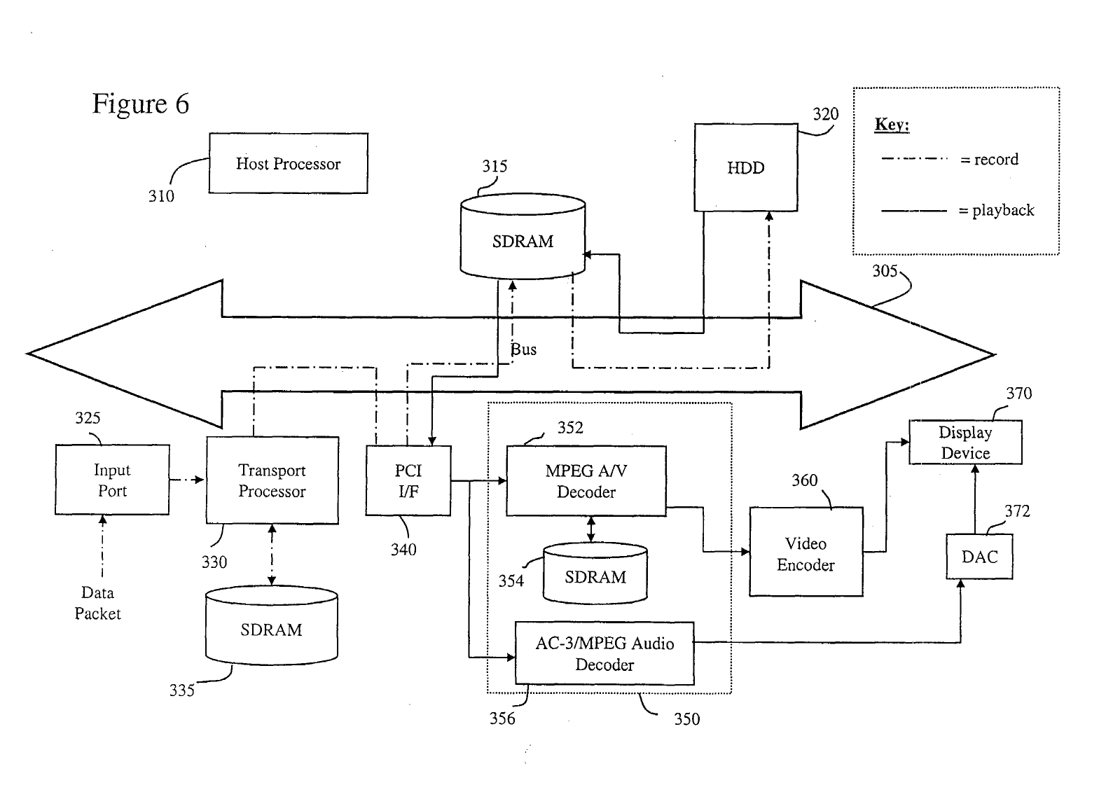

The recording and playback paths of the STB 300 are described in accordance with FIGS. 5 and 6. FIG. 5 shows the recording and playback data flows among the various components of the STB 300. Some of the connections between components, and associated reference numerals from FIG. 3 may have been eliminated in FIGS. 5 and 6 in order to highlight the data flow which is shown using dashed lines (see Key) in FIGS. 5 and 6

As shown in FIG. 5, A/V data of a selected or desired event, program and/or broadcast is received by input port 325 (typically the data is received in packetized and encrypted form) and fed to the transport processor 330. The transport processor 330 then transfers the received A/V data to SDRAM 315. Digital recording is accomplished by the host processor 310, which transfers the A/V data buffered by SDRAM 315 to the HDD 320. In other words, the SDRAM 315 serves as a buffer that buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

FIG. 6 illustrates an alternative signal path for recording. Audiovisual data is fed from the input port 325 to the transport processor 330. The transport processor 330 then transfers the received audiovisual data to the PCI I/F 340, as indicated by the dashed data flow line. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that buffers data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, etc. in STB 300 is now described. Referring again to FIG. 5, when the viewer turns the STB 300 on, the viewer is given the option to playback any of the previously recorded programs, events, broadcast, etc. This may be done, for example, by using a remote control or other suitable user command interface (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 to transport processor 330, back to bus 305 and then to PCI I/F 340, which in turn sends the selected A/V data to decoder 350. More specifically, the video portion of the bitstream is sent to MPEG A/V decoder 352, with the audio portion being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to video encoder 360 for conversion to an analog format, so that it may be displayed on display device 370. From this point on, the playback data looks, for all intents and purposes, identical to the originally recorded event, program, broadcast, etc.

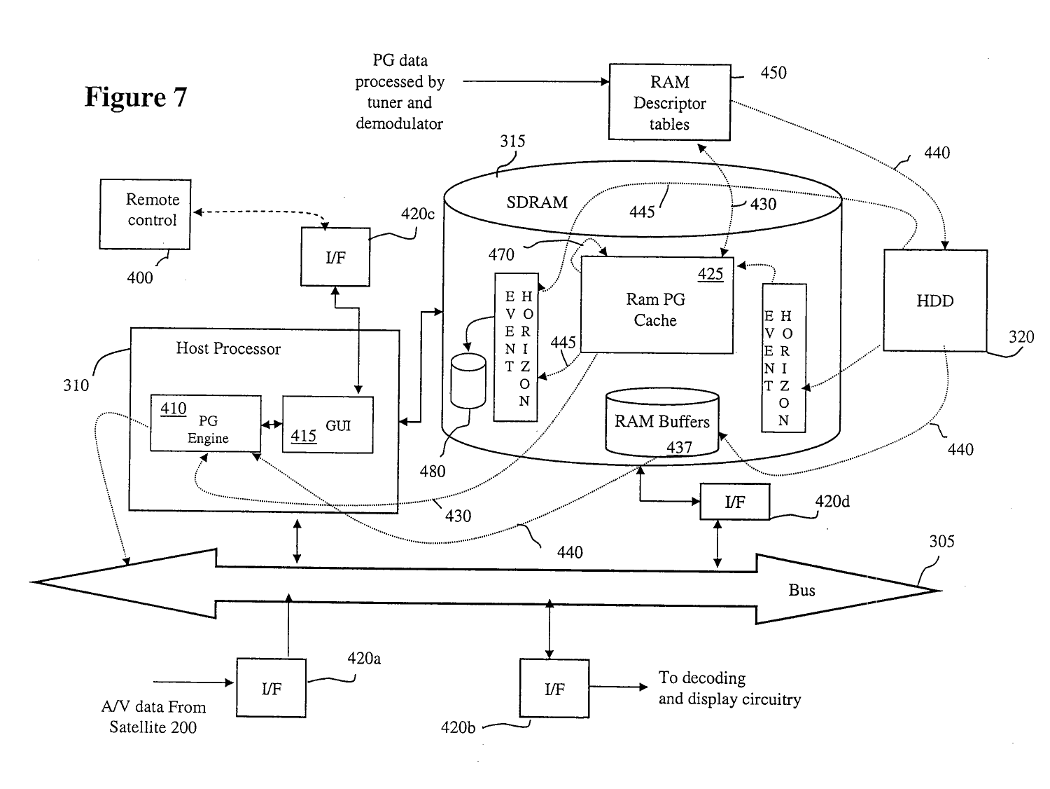

The architecture of the STB 300 and the operations of recording and playback having been described, the method and system to temporally sort electronic program guide data are now explained in light of the above description. FIG. 7 illustrates the method of organizing temporal program content in accordance with the invention.

In FIG. 7, there is a partial view of certain components of STB 300 in order to facilitate understanding of the invention. In FIG. 7, host processor 310 further includes a program guide engine 410 which may be accessed via a command graphical user interface (GUI) 415 to generate or implement applications to display a program guide on display 370. As previously noted, host processor 310 performs non real-time functions in the STB 300, such as graphical-user interface and browser functions. GUI 415 is responsible for formatting and displaying user-interface components and pictures.

Program guide data may be stored in bulk or mass storage, such as in HDD 320, and/or in physical memory such as in SDRAM 315, by a program guide engine 410 for use by GUI 415. Various hardware/external interfaces, such as input port 325, PCI I/F 340 in FIG. 3, SDRAM I/F 314 in FIG. 4, etc., collectively labeled as 420a-d in FIG. 7, are also operatively connected via data bus 305 to host processor 310 and hence program guide engine 410. These interfaces are of course responsible for operations such as receiving audiovisual bitstreams such as MPEG-1 and MPEG-2 bitstreams that are transmitted from a communications channel of satellite 200; outputting audio and video to display 370 or another suitable data device (e.g., audio to a stereo receiver); connection to an external phone line for billing purposes (not shown); receiving input from remote control 400, interfacing memory devices to data bus 305, etc.

GUI 415 includes various menu screens for setup, preferences, etc., but one screen provides a program guide menu (not shown) based on the program guide data generated by program guide engine 410. As previously discussed, the program guide is displayed as a menu, for example, in a matrix with times across the top of the screen of display 370 in ½ hour increments, with channels along the left edge and with programs identified at the cross sections of the times and the channels. The program guide may also carry other useful information, such as actors, ratings, description of programs, cost for pay per view (PPV) events, satellite frequency, video channel within frequency, audio channel(s) with frequency, video channel with frequency, audio stored in a mass storage device such as HDD 320 and/or within physical memory such as SDRAM 315 for later retrieval and use by the program guide engine 410.

Physical memory such as SDRAM 315 may include a RAM PG cache section 425 for temporary storage of program guide data that is to be accessed buy PG engine 410. RAM PG cache 425 may temporarily store and process several types of program guide data. Accordingly, the following data types, classified essentially by time, age and/or priority, are now defined in light of FIG. 7, where elements represent the various data streams.

For example, program guide data may include “now” data 430, which is truly immediate PG data such as changing of the channel by a user of STB 300, or real time content received from the satellite that actually changes as the viewer or user is looking at it. Additionally, now data 430 may be immediate future program guide data such as user command (i.e., via remote control 400 and GUI 415) to scroll through the program guide menu in order to display events in the program guide that are showing 2 hours hence. Thus, critical sections of cache in SDRAM 315 such as RAM PG cache 425 are necessary in order to efficiently process this data in for immediate viewing by the user. For purposes of this invention, now data may be defined as all program guide data that falls within the time window of the present time (now) and 6 hours from present time.

“Recently now data” 435 is program guide data which is further off in the future than “now data”. For example, “recently now data” 435 is program guide data 6 hours or more into the future. This data is conveniently stored in HDD 320 and/or additional RAM buffers 437 in SDRAM 315 to avoid burdening RAM PG cache 425. Programming information is broken up this way because most users will request now data 430 than recently now data 435. For example, when bringing up the guide, the average user will most likely be interested in programs that are being broadcast immediately on various channels than programs that are being broadcast a day from now. In this scenario more probable accesses are treated by accessing the data from RAM-based high speed temporal cache. Yet recently now data 435 is still available by accessing off of the slower mass storage device.

Obsolete data 445 is that program guide data no longer required by the STB 300. As will be discussed below, obsolete data 445 may be sent to a suitable disposal area 480 in SDRAM for deletion from either the HDD 320 or RAM PG cache 425, via one of the event horizon processes. These event horizon processes are hereinafter also referred to as low-priority background processes implemented in order to reduce contention on HDD 320, thereby making other STB 300 operations such as digital recording possible.

The method of the invention is now described in reference to the FIG. 7. As previously stated, an aspect of the invention is the conversion of a large number of real time events into casual background processing. This low-priority background processing approach additionally reduces the contention, or applications on the STB 300 vying to access program guide data on the HDD 320. This low-priority background processing approach ensures that the operation of other system features such as digital recording is possible and efficient. Additionally, this intelligent (i.e. application knowledgeable) caching of relevant program guide data improves the overall performance of channel changing, program guide display, etc.

One assumption is that the most-used or near-term now data 430 is most likely to be accesses, as compared to the recently now data 435 or future data 440. This is based on a principle that events or program guide data to be accessed “now” are of more interest to the user than program guide data that would likely be accessed two days, a week or ten days in the future.

Accordingly, the method utilizes two low-priority background processes, event horizons 455 and 465. These two processes (or algorithms), which are directed by PG engine 410 within host processor 310, represent processes used in conjunction with short-term cache and long-term storage respectively, in an effort to reduce contention on HDD 320 and to optimize the storage required by high-speed RAM PG cache 425. Instead of running real time, these event horizons 455 and 465 are run as low-priority background processes by PG engine 410, to be performed at a time when there are no immediate or “now” program guide accesses being implemented by PG engine 410 based on user instructions received through GUI 415.

In FIG. 7, program guide data received from a communications channel of the satellite 200 is tuned and demodulated in the STB 300 and sent to RAM descriptor tables 450. These RAM descriptor tables 450 separate the received program guide data and may be embodied as a plurality of buffers that could be part of existing SDRAM 315, or alternatively part of a separate physical memory device. From the RAM descriptor tables 450, now data 430 is sent directly to RAM PG Cache 425, and future data 440 is stored directly in HDD 320.

Depending on the priority of the future data 440 stored in HDD 320, and/or based on user commands, some of that data may become recently now data 435, where it is accessed by one of the low-priority background processes, here illustrated as event horizon 455. Direct now data 430 and some recently now data 435 accessed via event horizon 455 are subject to conditional access (CA) processing 470 in RAM PG Cache 425. CA processing 470 is effected at 2 minute intervals to determine whether the user of the programming has rights to see all programs listed in the program guide data (i.e., all programming that the user has paid for either by subscription, PPV, etc.).

Accordingly, due to this temporal sorting of program guide data, the most used or near-term data (now data 430) is kept in the high-speed RAM PG cache 425 to run applications that are to be displayed on a screen of display 370 where a the lower-priority program guide data (recently now-data 435) is back-filled or added into RAM PG Cache 425 via event horizon 455, at periodic times, for eventual processing by PG engine 410 as program guide data to run applications that are to be displayed on a screen of display 370 sometime in the future. Additionally, even lower-priority future data 440 may be sent directly to PG Engine 410 at the appropriate point in time, via additional RAM Buffers 437, to be accessed to run applications for program guide display. Of course, this lowest priority future data is processed at a lower speed, since it is assumed to be of least interest to the consumer, and so as not to interfere with other, higher-priority HDD 320 accesses that may be occurring simultaneously.

Thus, contention for HDD 320 regarding accesses of program guide data are kept to a minimum by the low-priority background filling through event horizon process 455, which ensures that the high-speed RAM PG Cache 425 maintains a predetermined window of cached now data 430. Contention is further avoided by using a second low-priority background or event horizon process 465, which periodically prunes both RAM PG cache 425 and HDD 320 to remove no longer used or needed program guide data (obsolete data 445), which is sent to a suitable “trash can” disposal area 480 for deletion. Moreover, the event horizons 455 and 465 are designed to run so as not to interfere with accesses of the now data for applications being currently implemented by PG engine 410.

The method of temporally organizing program guide data thus allows the RAM PG cache 425 to be subject to certain accesses to the now data 430 contained therein without having to access the HDD 320. Besides the obvious now data accesses by PG engine 410 when the user sends a command via GUI 415, RAM PG cache 425 may be able to cache other possible types of data such as DVR meta data in order to record something with parental control on playback, for example, or other recording uses. The more this near-term, now data 430 is kept available for immediate access, based on the principle that this is the program guide data that is most likely to be used by the user or viewer, the greater the overall performance of basic STB 300 features such as channel changing, program guide display, recording etc.

The method and system of the invention offers several advantages. Size of the RAM PG cache 425 may be optimized based on the temporal window that encompasses most common usage scenarios employing now data 430. With the back-filling of recently now data 435 via event horizon process 455, relevant program guide data may be “pre-fetched” from HDD 320 as PG engine 410 detects usage scenarios likely to result in a cache miss (i.e., to detect that the user is scrolling forward in time in the program guide and likely to need program guide data that is not currently in Ram PG cache 425). In line with this, synchronous HDD 320 accesses may be effected when cache miss cannot be predicted and overcome.

Another advantage may be application speed enhancement, due to the fact that only the most often used or near-term now data 430 is cached in RAM PG cache 425. This also may advantageously require less-expensive high-speed RAM requirements in the STB 300, providing cost benefits to the manufacturer and possibly the consumer. Moreover, since only the most often used or near-term now data 430 is cached in RAM PG cache 425, there is a reduction in mass storage usage on HDD 320, providing for efficient operation of advanced STB 300 features such as digital video recording, high-speed reverse playback, parental control of recorded programming, etc.

The invention being thus described, it will be obvious that the same may be varied in many ways. For example, the functional blocks in FIGS. 1-7 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s). Such variations are not to be regarded as departure from the spirit and scope of the invention, and all such modifications as would be obvious to one skilled in the art are intended to be included within the scope of the following claims.

What is claimed is:

1. A system for accessing program guide data, comprising:
a set top box, comprising:
a physical memory;
a mass storage device; and
a processor coupled to the physical memory and the mass storage device, wherein the processor is configured to sort the program guide data into near-term data and long-term data, the near-term data being stored in the physical memory and the long term data being stored in the mass storage device, such that at least the sorting of the program guide data is suspended when the near-term data is accessed.

2. The system of claim 1, wherein the processor removes a portion of the near-term data from the physical memory.

3. The system of claim 2, wherein the processor moves a portion of long-term data from the mass storage device to the physical memory.

4. The system of claim 1, wherein the processor sorts the program guide data based on an event horizon.

5. The system of claim 1, wherein the near-term data is accessed independent of the long-term data.

6. The system of claim 1, wherein a size of the physical memory is selected based on probabilities of accessing the near-term data.

7. The system of claim 1, wherein the program guide data is delivered to the set top box via a communications channel.

8. The system of claim 7, wherein the communications channel is one of a satellite communications channel, a cable communications channel, a digital video broadcasting (DVB) communications channel, and a terrestrial broadcast communications channel.

9. A method for accessing program guide data, comprising:
delivering the program guide data to a set top box;
sorting the delivered program guide data into near-term data and long-term data;
storing the near-term data in a first memory;
storing the long-term data in a second memory; and
suspending at least the sorting of the program guide data when accessing the near-term data.

10. The method of claim 9, further comprising removing a portion of the near-term data from the first memory when an event horizon is reached.

11. The method of claim 10, further comprising moving a portion of the long-term data from the second memory to the first memory.

12. The method of claim 9, wherein sorting the program guide data is based on an event horizon.

13. The method of claim 9, wherein accessing the near-term data is performed independent of accessing the long-term data.

14. The method of claim 9, further comprising configuring a size of the first memory based on probabilities of accessing the near-term data.

15. The method of claim 9, wherein delivering the program guide data is performed via a communications channel.

16. The method of claim 15, wherein the communications channel is one of a satellite communications channel, a cable communications channel, a digital video broadcasting (DVB) communications channel, and a terrestrial broadcast communications channel.

17. A program guide data storage system, comprising:
a first memory having a first access speed;
a second memory having a second access speed lower than the first access speed; and
a processor, coupled to the first memory and the second memory, the processor configured to sort program guide data into near-term data and long-term data based on an event horizon which determines whether the program guide data is near-term data or long-term data, wherein the processor causes the near-term data to be stored in the first memory and the long-term data to be stored in the second memory, such that when the near-term data is accessed, the sorting of the program guide data is suspended.

18. The system of claim 17, wherein the processor removes the near-term data from the first memory when a current time is greater than a time associated with the near-term data being removed.

19. The system of claim 18, wherein the processor moves a portion of the long-term data from the second memory to the first memory.

20. The system of claim 19, wherein the processor moves the long-term data based on an event horizon.
